(19) United States
(12) Patent Application Publication
(10) Pub. No.: US 2018/0300886 A1
(43) Pub. Date: Oct. 18, 2018

(54) SYSTEM AND METHOD OF PRODUCING AND DISPLAYING VISUAL INFORMATION REGARDING GAS CLOUDS

(71) Applicant: Pixel Velocity, Inc., Ann Arbor, MI (US)

(72) Inventors: Ali Mustafa, Dearborn, MI (US); David McCubbrey, Ann Arbor, MI (US); Dirk Colbry, Okemos, MI (US); Eric Larson, Ann Arbor, MI (US)

(21) Appl. No.: 15/768,164

(22) PCT Filed: Oct. 11, 2016
(86) PCT No.: PCT/US16/56357

§ 371 Date: Apr. 13, 2018

Related U.S. Application Data
(60) Provisional application No. 62/242,054, filed on Oct. 15, 2015.

(51) Int. Cl. G06T 7/285; G06T 11/00; G01N 21/3504

(52) U.S. Cl. CPC G06T 7/285; G01N 21/3504; G06T 11/001

(57) ABSTRACT

A system for detecting a gas cloud has a camera having an image sensor, a display device and a processor. The processor is in communication with both the image sensor and the display device. The image sensor is configured to capture a plurality of images of a field of view. The processor being configured to receive the plurality of images from the camera, generate metadata from the plurality of images, evaluate the gas cloud based on the metadata and the internal component movements of the gas cloud if the gas cloud is being emitted from a single leakage point, and generate a color encoded image of the field of view. The color encoded image utilizing at least one color to display at least one attribute of the gas cloud and the single leakage point on the display device.

### CROSS REFERENCE TO RELATED APPLICATION

This application claims priority to U.S. Provisional Application No. 62/242,054 filed on Oct. 15, 2015 all of which are herein incorporated by reference in their entirety.

### BACKGROUND

### 1. Field of the Invention

The present invention generally relates to systems and methods of detecting gas clouds, especially hydrocarbon gas clouds that are invisible to the human eye.

### 2. Description of Related Art

Gas clouds may form during the release of a gas or the vaporization of a liquefied gas. In some cases, gas and gas clouds may be made of flammable material. If ignition does not occur immediately at the origin of the release, then a gas cloud can form. A delayed ignition of the gas cloud can result in a flash fire or explosion in which the gas cloud burns rapidly. The resulting fire or explosion may result in damage to a pipeline or storage tank, resulting in even more gas released, possibly resulting in a larger explosion.

Generally, there are two ways in which gas clouds can be detected. The first requires continuous human viewing of a specialized infra-red sensitive hand-held camera image which does not provide any cloud detailed analysis. Essentially, the human operator must make a decision if a gas cloud is formed. Even the most skilled human operator will routinely make errors. In situations where a gas cloud was formed, but not detected by the human operator, a dangerous situation could occur resulting in fire or explosion. In situations where a gas cloud was not formed but was believed to be formed by the human operator, resources are expended that did not need to be.

The other way and which gas clouds can be detected are through the use of simple pixel-level change detection to produce indications of the presence of a hydrocarbon gas cloud. These systems display blob-like shapes that do not show any detailed time-space patterns of the gas clouds' interior structural interior density, emitted signal intensity, or motion patterns. As a result, the selectivity and the reliability of the displayed data do not provide visual cues to a human operator that would enable rapid and accurate discrimination of hydrocarbon gas clouds from normal and unimportant ambient atmospheric, foliage motion or other phenomena, nor motions of other unimportant objects in the imaging sensor's field of view.

### SUMMARY

A system for detecting a gas cloud has a camera having an image sensor, a display device and a processor. The processor is in communication with both the image sensor and the display device. The image sensor is configured to capture a plurality of images of a field of view. The processor being configured to receive the plurality of images from the camera, generate metadata from the plurality of images, evaluate the gas cloud based on the metadata and the internal component movements of the gas cloud if the gas cloud is being emitted from a single leakage point, and generate a color encoded image of the field of view. The color encoded image utilizing at least one color to display at least one attribute of the gas cloud and the single leakage point on the display device.

A method for detecting gas clouds, includes the steps of receiving the plurality of images from the camera, generating metadata from the plurality of images, evaluating internal component movements of the gas cloud, evaluating based on the metadata and the internal component movements of the gas cloud if the gas cloud is being emitted from a single leakage point, generating a color encoded image of the field of view, the color encoded image utilizing at least one color to display at least one attribute of the gas cloud and the single leakage point, and displaying the color encoded image on a display device.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a system for detecting gas clouds, especially hydrocarbon gas clouds;

FIG. 2 illustrates a method for detecting gas clouds; and

FIGS. 3A, 3B, and 3C display different color encoded images illustrating at least one attribute of a gas cloud.

### DETAILED DESCRIPTION

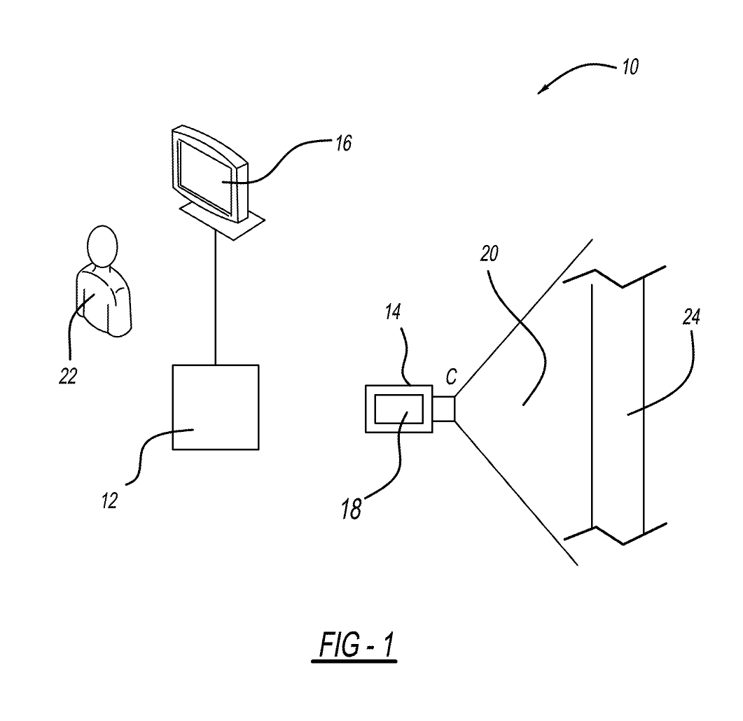

Referring to FIG. 1, a system 10 for detecting gas clouds is shown. As its primary components, the system 10 includes a processor 12 being in communication with a camera 14 and a display 16. The camera 14 may include an image sensor 18 for capturing images of a field of view 20. It should be understood that the system 10 may include a single camera 14, as shown, or may include a plurality of cameras capturing one or more fields of view 20.

The camera 14 may be any camera capable of revealing the gas cloud may be used in the system. The camera 14 preferentially is one that is sensitive to radiation in the region of a so-called absorption band of the gas or gasses to be detected. Radiation at the wavelength of an absorption band will be attenuated as it passes through the gas, giving a dark cloudy or smoky appearance to a human viewer. An example of such a camera is the G300a, manufactured by FLIR, Inc. of Wilsonville, Oreg.

With regards to the processor 12, the processor 12 may be a single processor, such as a digital signal processor, or may be a plurality of processors working in concert. The display 16 may be a single display device, such as a flat panel display, but may also include a plurality of displays so as to display information to a human operator 22.

The field of a view 20 may include a pipeline 24 that is capable of transporting a gas and/or liquid. The gas and/or liquid carried by the pipeline 24 may be a flammable hydrocarbon gas and/or liquid. As such, a leak in the pipe 24 will result in a gas cloud caused by gas leaking from the pipeline 24 or the vaporization of a liquefied gas carried by the pipeline 24. If such a leak occurs, a dangerous situation could develop, wherein the resulting gas cloud may ignite causing further damage to the pipeline 24 or objects or persons near the pipeline 24.

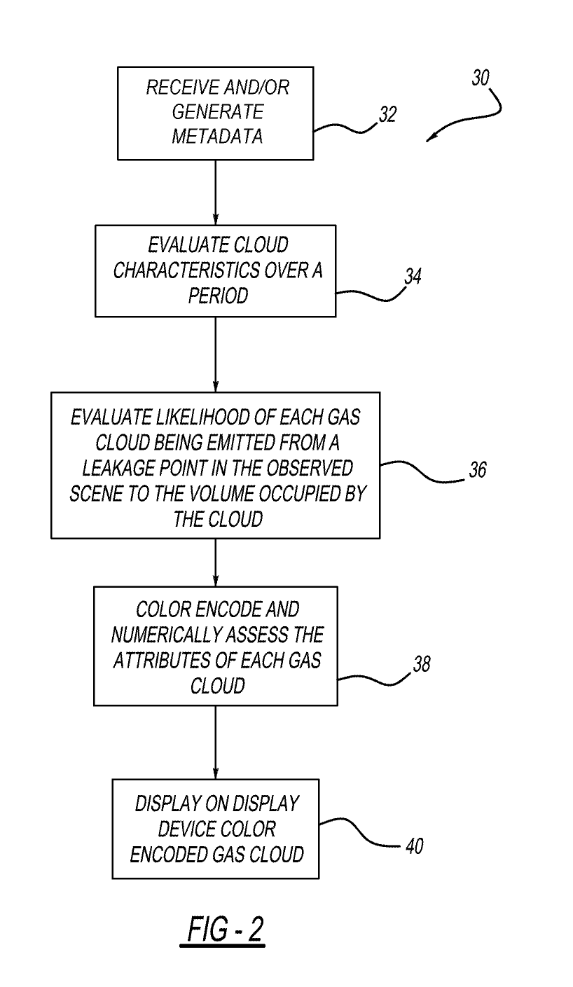

Referring to FIG. 2, a method for detecting a gas cloud is shown. The method 30 includes a step 32 of receiving metadata via the processor 12 from the camera 14 describing the gas cloud. Alternatively, the method may first receive by the processor 12 the plurality of images from the camera 14 and then generate metadata from the plurality of image by the processor 12. The metadata is generated by means of computer analysis of a sequence of images from the camera 14. The metadata may describe the internal rapid time history of the shape, resolvable internal component movements and intensities, and/or the internal structure and location of each observed bounded atmosphere region known as the gas cloud. This analysis may be performed within the camera using an embedded computer, but may instead be performed by processor 12 based on images received from the camera.

In step 34, the processor 12 evaluates the characteristics of the gas cloud over a period. This evaluation may be repeatedly and numerically performed over a short period of time, such as less than 10 seconds with high time resolutions such as less than 1 second.

In step 36, the processor 12 evaluates the likelihood of each gas cloud being emitted from a leakage point in the pipeline 24 in the field of view 20 to the volume occupied by the cloud.

This evaluation may be based on the metadata and the internal component movements of the gas cloud if the gas cloud is being emitted from a single leakage point. In step 38, the processor color encoded and numerically assesses the attributes of each gas cloud. The color chosen for the gas cloud could indicate one of the attributes of the gas cloud. Finally, in step 40, the processor 12 displays on the display device 16 the color encoded gas cloud.

Colors are assigned to indicate three levels of algorithm attention—gas-like clouds, gas-like clouds that have repeatedly been observed in the same general area over a short period of time, and gas-like clouds that have occurred in the same general area over a longer period of time that is sufficient to declare them as part of an actual gas leak.

Referring to FIGS. 2A, 2B, and 2C, images 50A, 50B and 50C are images that may be displayed by the display device 16 of FIG. 1. Here, color encoded gas clouds 52A, 52B, and 52C are shown. The purpose of the color encoded gas clouds is to allow the operator 22 of the system 10 to better determine if the gas cloud is indeed caused by a leak.

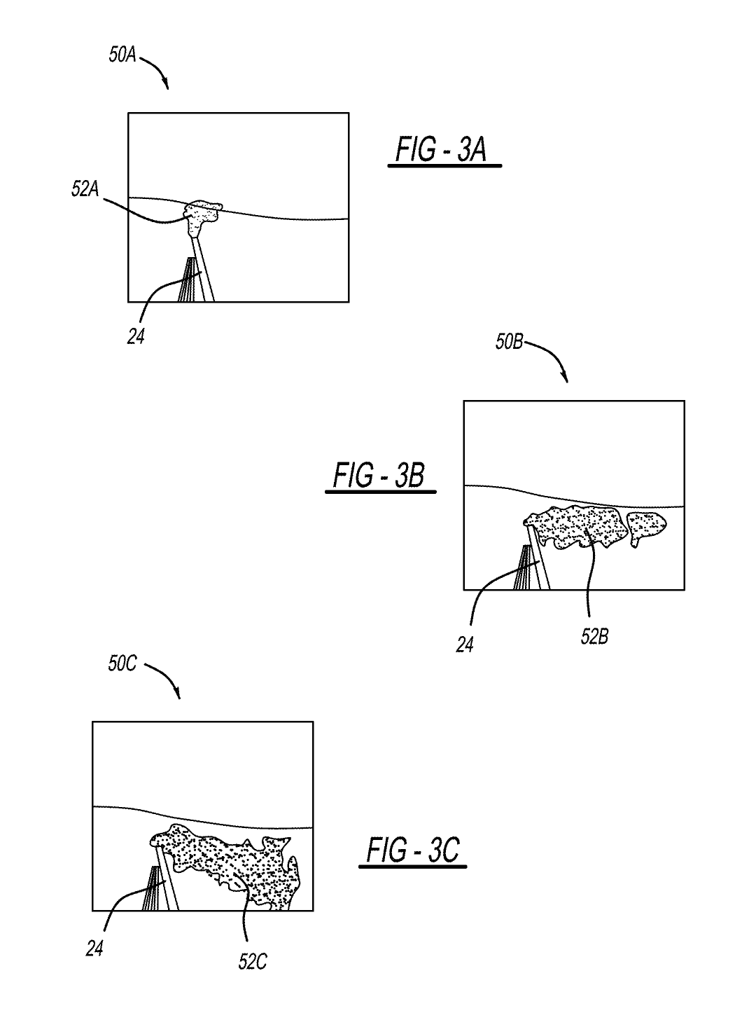

As shown in FIG. 3A, one can see that there is a small gas cloud formed by a pipeline 24. At this time it may not be clear to the operator 22 if the gas cloud is indeed caused by a leak in the pipeline 24. However, as the progression of the gas cloud is shown in FIGS. 2B and 2C, it becomes readily apparent to the operator 22 that the gas cloud is indeed being emitted by a leak located within the pipeline 24. As such, the operator 22 can easily and readily visually identify that there is an issue in this section of the pipeline 24 and take the appropriate action to minimize the leak further. This action can include repairing the pipeline and/or shutting the pipeline down to prevent any further release of gases.

An alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A system for detecting a gas cloud, the system comprising
a camera having an image sensor, the image sensor being configured to capture a plurality of images of a field of view;
a processor in communication with the image sensor;
a display device in communication with the processor; and
the processor being configured to:
receive the plurality of images from the camera,
generate metadata from the plurality of images describing at least one of a history of the gas cloud, internal component movements of the gas cloud, or an internal structure of the gas cloud,
evaluate the internal component movements of the gas cloud,
evaluate based on the metadata and the internal component movements of the gas cloud if the gas cloud is being emitted from a single leakage point,
generate a color encoded image of the field of view, the color encoded image utilizing at least one color to display at least one attribute of the gas cloud and the single leakage point, and
display the color encoded image on the display device.

2. The system of claim 1, wherein the metadata describes the history of the gas cloud, the internal component movements of the gas cloud, and the internal structure of the gas cloud.

3. The system of claim 1, wherein the history of the gas cloud includes the history of the shape of the gas cloud.

4. The system of claim 1, wherein the processor is further configured to determine if the gas cloud is one of: gas-like clouds, gas-like clouds that have repeatedly been observed in the same general area over a short period of time, or gas-like clouds that have occurred in the same general area over a longer period of time that is sufficient to declare them as part of an actual gas leak.

5. The system of claim 4, wherein the processor is further to select the color for the color encoded image based on the determination that the gas cloud is one of: gas-like clouds, gas-like clouds that have repeatedly been observed in the same general area over a short period of time, or gas-like clouds that have occurred in the same general area over a longer period of time that is sufficient to declare them as part of an actual gas leak.

6. The system of claim 1, wherein the camera is sensitive to radiation in the region of an absorption band of a gas to be detected, whereby radiation at the wavelength of the absorption band will be attenuated as radiation passes through the gas.

7. A method for detecting gas clouds, the method comprising the steps of:
receiving a plurality of images from a camera,
generating metadata based on the plurality of images received by the camera, the metadata describing at least one of a history of the gas cloud, internal component movements of the gas cloud, or an internal structure of the gas cloud;
evaluating the internal component movements of the gas cloud;
evaluating based on the metadata and the internal component movements of the gas cloud if the gas cloud is being emitted from a single leakage point;
generating a color encoded image of the field of view, the color encoded image utilizing at least one color to display at least one attribute of the gas cloud and the single leakage point; and
displaying the color encoded image on a display device.

8. The method of claim 7, wherein the metadata describes the history of the gas cloud, the internal component movements of the gas cloud, and the internal structure of the gas cloud.

9. The method of claim 7, wherein the history of the gas cloud includes the history of the shape of the gas cloud.

10. The method of claim 7, further comprising the step of determining if the gas cloud is one of: gas-like clouds, gas-like clouds that have repeatedly been observed in the same general area over a short period of time, or gas-like clouds that have occurred in the same general area over a longer period of time that is sufficient to declare them as part of an actual gas leak.

11. The method of claim 10, further comprising the step of selecting the color for the color encoded image based on the determination that the gas cloud is one of: gas-like clouds, gas-like clouds that have repeatedly been observed in the same general area over a short period of time, or gas-like clouds that have occurred in the same general area over a longer period of time that is sufficient to declare them as part of an actual gas leak.

12. The method of claim 7, wherein the camera is sensitive to radiation in the region of an absorption band of a gas to be detected, whereby radiation at the wavelength of the absorption band will be attenuated as radiation passes through the gas.
